(19) United States
(12) Patent Application Publication
(10) Pub. No.: US 2018/0077758 A1
(43) Pub. Date: Mar. 15, 2018

(54) SYSTEM AND METHOD FOR OPERATING AN INDUCTION COOKER

(71) Applicant: Haier US Appliance Solutions, Inc., Wilmington, DE (US)

(72) Inventors: Tae-Hoon Lim, Seongnam-si (KR); Dong Soo Shin, Seoul (KR); Jaebong Lee, Seongnam-si (KR)

(21) Appl. No.: 15/263,497

(22) Filed: Sep. 13, 2016

(51) Int. Cl. H05B 6/06; A23L 5/10; H05B 6/12

(52) U.S. Cl. CPC H05B 6/062; A23V 2002/00; H05B 6/1209; A23L 5/15

(57) ABSTRACT

A system for controlling the operation of an induction cooker includes a controller of the induction cooker and a personal electronic device. The controller may be communicatively coupled to a weight sensor of the induction cooker, and the controller may be configured to determine a weight of a food item within a cookware item that is positioned on the induction cooker. The personal electronic device may be in communication with the controller such that the personal electronic device may receive data indicating the determined weight of the food item. The system and related method for controlling the operation of the induction cooker includes determining, by the controller, the weight of the food item. The system and related method further include automatically adjusting the operation of the induction cooker based, at least in part, on the determined weight of the food item.

### FIELD OF THE INVENTION

The present disclosure relates generally to induction cookers and a system and method for operating induction cookers.

### BACKGROUND OF THE INVENTION

Induction cookers may be used to heat a cookware item by magnetic induction. Induction cookers typically include a coil positioned beneath a cooking surface on which the cookware item rests. In operation, an electric current flows through the coil such that the coil emits a magnetic field. The magnetic field induces a magnetic flux which repeatedly magnetizes the cookware item. The magnetic flux produces eddy currents within the ferromagnetic material that comprises the cookware item. The eddy currents heat the cookware item and a food item contained therein.

Induction cookers also typically include a control panel having a display and one or more buttons. Through the use of the buttons, a user may manually select/adjust one or more cooking parameters, such as a cook time or a heating level. However, an optimal cook time can vary depending upon numerous factors, such as weight of the cookware and the food item therein. Selection of a cook time and/or heating level that is less than optimal may result in the food item being undercooked or overcooked.

Accordingly, an induction cooker with features for automatically adjusting the operation of the induction cooker based on the sensed weight of the food item would be useful. In particular, a system and method for automatically adjusting one or more cooking parameters based on the sensed weight of the food item would be welcomed.

### BRIEF DESCRIPTION OF THE INVENTION

Aspects and advantages of the invention will be set forth in part in the following description, or may be obvious from the description, or may be learned through practice of the invention.

In a first exemplary embodiment, a method for controlling the operation of an induction cooker is provided. The method includes determining, by a controller of the induction cooker, a weight of a cookware item positioned on the induction cooker. The method further includes determining, by the controller of the induction cooker, a weight of a food item disposed within the cookware item. In addition, the method includes automatically adjusting the operation of the induction cooker based, at least in part, on the determined weight of the food item.

In a second exemplary embodiment, a system for controlling the operation of an induction cooker includes a controller and a personal electronic device. The controller may be communicatively coupled to a weight sensor of the induction cooker. Further, the controller may be configured to determine a weight of a food item within a cookware item positioned on the induction cooker. The personal electronic device may be in communication with the controller, and the personal device may be configured to receive data from the controller. The data may at least indicate the determined weight of the food item. In addition, the controller or the personal electronic device may be configured to automatically adjust the operation of the induction cooker based, at least in part, on the determined weight of the food item.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front perspective view of an induction cooker according to an exemplary embodiment of the present disclosure;

FIG. 2 provides a top view of the exemplary induction cooker of FIG. 1;

FIG. 3 provides a block diagram of a controller according to an exemplary embodiment of the present disclosure;

FIG. 4 provides a top cutaway view of the exemplary induction cooker of FIG. 1;

FIG. 5 provides a bottom view of the exemplary induction cooker of FIG. 1;

FIG. 6 provides a schematic of an exemplary system for controlling the operation of the induction cooker of FIG. 1; and

FIG. 7 provides an exemplary method for controlling the operation of the induction cooker of FIG. 1.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

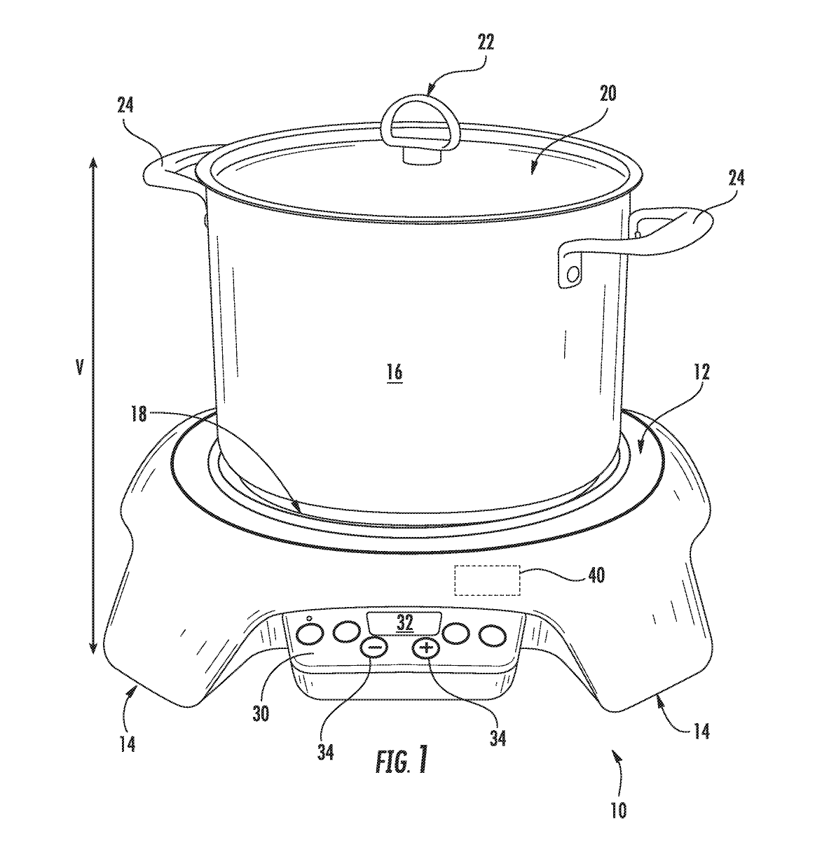

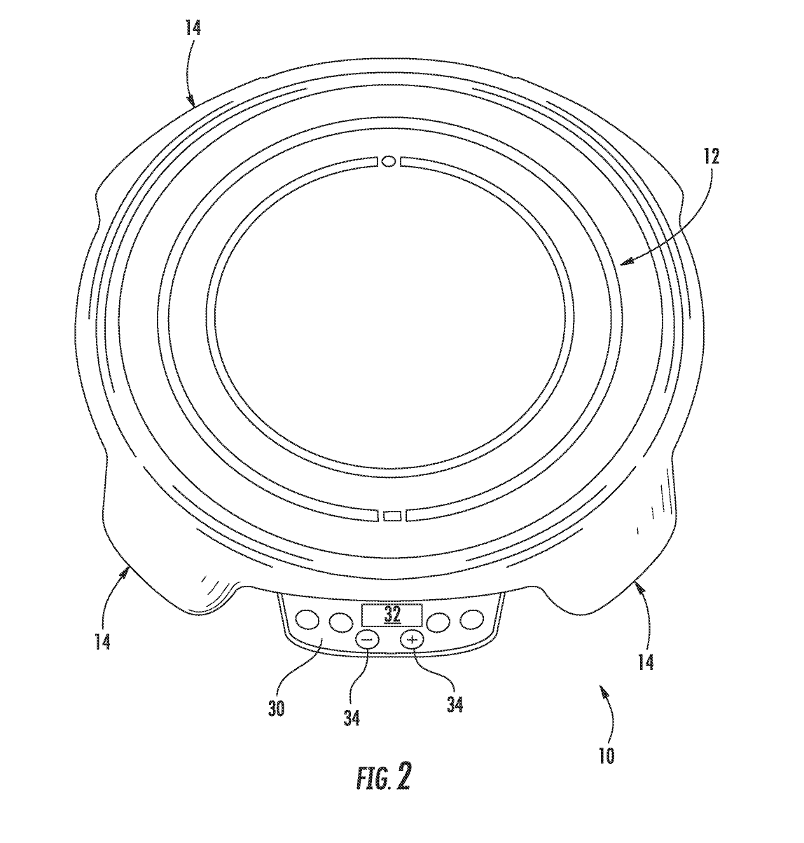

FIGS. 1 and 2 illustrate an induction cooker 10 in accordance with an exemplary embodiment of the present disclosure. In particular, FIG. 1 provides a front, perspective view of the induction cooker 10, and FIG. 2 provides a top view of the induction cooker 10. The induction cooker 10 may include a top panel or plate 12 and a plurality of supports 14. The top plate 12 may be comprised of ceramic glass or any other suitable material. The plurality of supports 14 may extend from the top plate 12 along a vertical direction V. Further, in some exemplary embodiments, the plurality of supports 14 may be spaced apart from one another along a perimeter of the top plate 12.

As shown in FIG. 1, a cookware item 16, such as a cooking pot, may be positioned on the top plate 12. More specifically, a bottom surface 18 of the cookware item 16 may contact the top plate 12 of the induction cooker 10 when the cookware item 16 is positioned on the top plate 12. The cookware item 16 may include a lid 20 having a handle 22. The lid 20 may be removed from the cookware item 16 via the handle 22. In particular, the lid 20 may be removed to access a cavity defined by the cookware item 16. The cavity may receive the food item to be cooked via the induction cooker 10. The cookware item 16 may also include opposing handles 24. In particular, opposing handles 24 may be used when moving the cookware item 16 onto and off of the top plate 12.

It should be appreciated that the cookware item 16 may be comprised of any suitable ferromagnetic material. As an example, in one exemplary embodiment, the cookware item 16 may be comprised of iron (Fe). In another exemplary embodiment, the cookware item 16 may be comprised of nickel (Ni). In yet another alternative exemplary embodiment, the cookware item 16 may be comprised of cobalt (Co). It should also be appreciated, however, that the cookware item 16 may be comprised of any suitable alloys of iron (Fe), nickel (Ni), or cobalt (Co).

The induction cooker 10 may also include a control panel 30 having a display 32 and a plurality of input buttons 34. The display 32 may be a liquid crystal diode (LCD) display that provides visual information to a user. For example, the visual information may include textual information indicating a temperature of the induction cooker 10, specifically the top plate 12 or the cookware item 16 on top plate 12. The plurality of input buttons 34 may be used to adjust one or more settings of the induction cooker 10. For example, a cook time may be increased or decreased through the use of one or more of the plurality of buttons 34. As will be discussed below in more detail, the operation of the induction cooker 10 is controlled by a processing device or controller 40 that may be operatively coupled to the control panel 30.

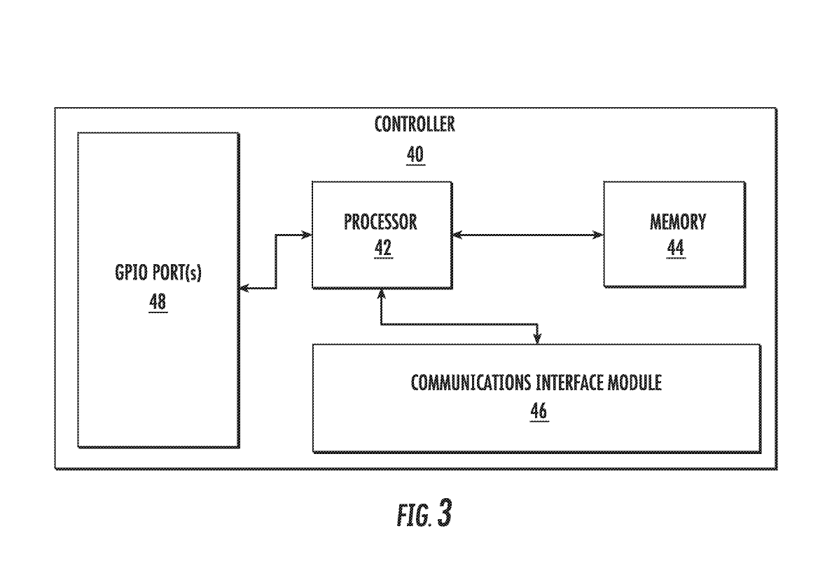

Referring now briefly to FIG. 3, the controller 40 may generally include one or more processor(s) 42 and associated memory 44 configured to perform a variety of computer-implemented functions (e.g., performing the methods, steps, calculations and the like disclosed herein). As used herein, the term “processor” refers not only to integrated circuits referred to in the art as being included in a computer, but also refers to a controller, microcontroller, a microcomputer, a programmable logic controller (PLC), an application specific integrated circuit (ASIC), and other programmable circuits. Additionally, the memory 44 may generally include memory element(s) including, but not limited to, a computer readable medium (e.g., random access memory (RAM)), computer readable non-volatile medium (e.g., flash memory), a floppy disk, a compact disc-read only memory (CD-ROM), a magneto-optical disk (MOD), a digital versatile disc (DVD) and/or other suitable memory elements.

The controller 40 may also include a communications interface module 46. The communications interface module 44 includes associated electronic circuitry that is used to both send and receive data. As an example, the communications interface module 46 may be used to send and receive data to and from the controller 40. It should be appreciated that the communications interface module 46 may be any suitable wired or wireless communications interface module. For example, the communications interface module 44 may provide communications between the controller and one or more remote devices (e.g., personal electronic device) on a wireless personal area network (WPAN). More specifically, the communications interface module 44 may be configured to communicate with the one or more devices using the Bluetooth® protocol. In other embodiments, the communications interface module 46 may provide communications between the controller and a remote device (e.g., personal electronic device) via a serial communications interface. In particular, the serial communications interface may be based on the Universal Serial Bus (USB) protocol.

Additionally, the controller 40 may include one or more general purpose input output (GPIO) port(s) 48. More specifically, the controller 40 may communicate with one or more peripheral devices of the induction cooker via the GPIO ports. For example, as will be discussed below in more detail, the controller 40 may communicate with a weight sensor via the GPIO port(s).

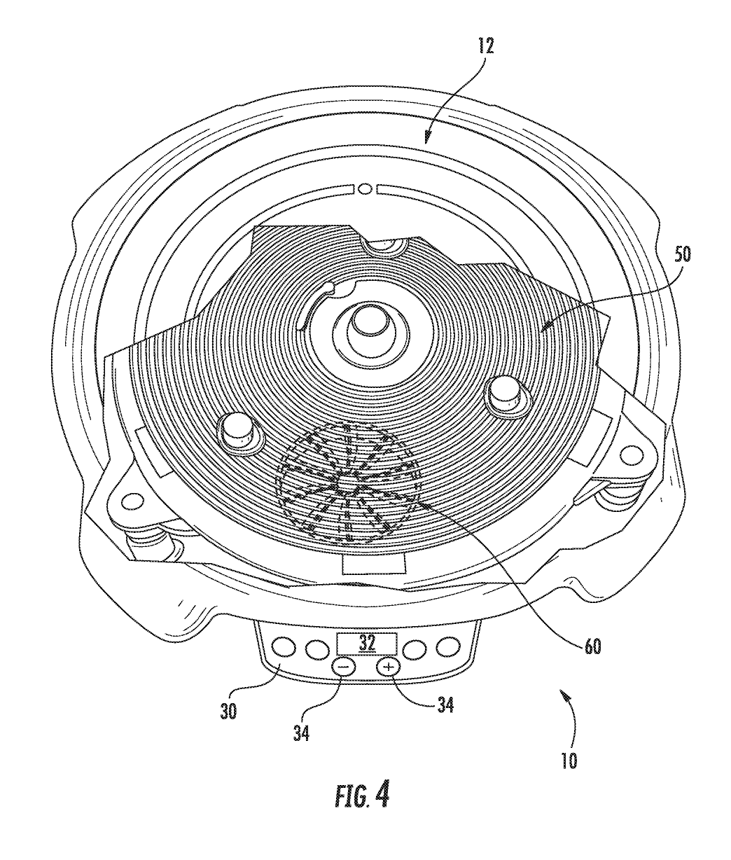

FIG. 4 provides a partial cutaway top view of the induction cooker 10. As shown, the induction cooker 10 includes an induction coil 50 positioned beneath the top plate 12 along the vertical direction V. The induction coil 50 includes a conductive material. For example, the induction coil 50 may be comprised of Litz wire. In operation, a time-varying magnetic field may be emitted from the induction coil 50 when an electric current (i.e., alternating current) flows through the induction coil 50. Further, the time-varying magnetic field may penetrate or engage the bottom surface 18 of the cookware item 16. Still further, the time-varying magnetic field induces one or more electric currents in the cookware item 16. These one or more electric currents are generally referred to as “eddy currents”, and these eddy currents dissipate heat that increases the temperature of the cookware item 16. Accordingly, the heat from the eddy currents may be used to cook the food item contained within the cavity of the cookware item 16.

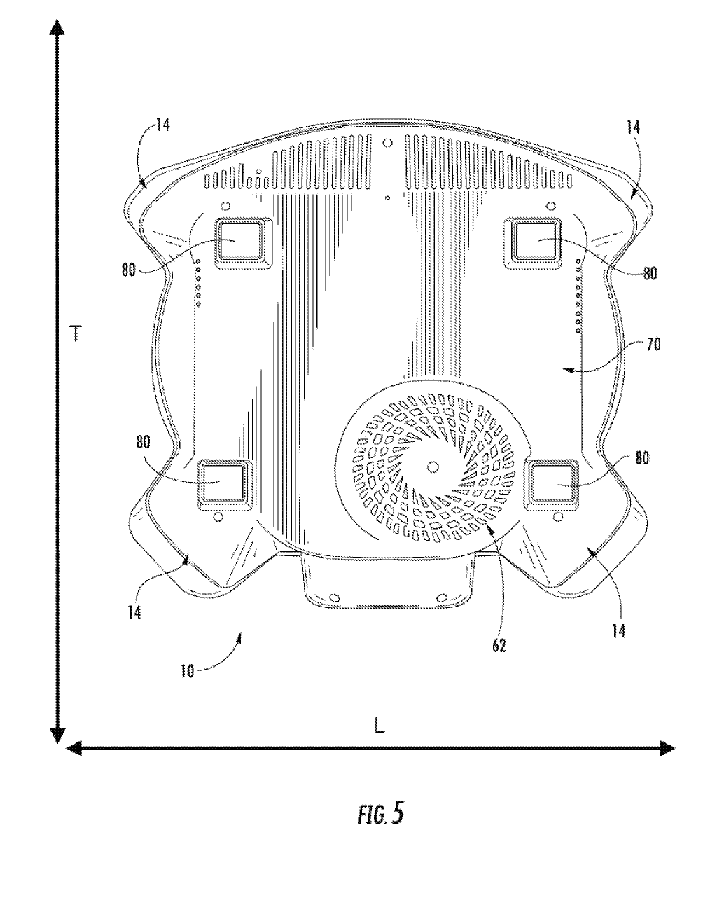

The induction cooker 10 also includes a fan 60 positioned beneath the induction coil 50 along the vertical direction V. The fan 60 may be operatively coupled to the controller 40. As such, the controller 40 may control the operation of the fan 60. More specifically, the controller 40 may operate the fan 60 to draw air through a vent 62 (FIG. 5) such that the air may cool the induction coil 50 and its associated electronics (e.g., power electronics). It should be appreciated that the vent 62 is positioned beneath the fan 60 along the vertical direction V.

FIG. 5 provides a bottom view of the induction cooker 10. As shown, the induction cooker 10 includes a bottom panel 70, e.g., positioned opposite top plate 12 at or adjacent supports 14. In addition, the induction cooker 10 may include one or more weight sensor(s) 80 mounted on the bottom panel 70. In the exemplary embodiment depicted in FIG. 5, the induction cooker 10 includes a plurality of weight sensors 80 spaced apart from one another along both a lateral direction L and a transverse direction T. Each of the plurality of weight sensors 80 may be communicatively coupled to the controller 40. Accordingly, the controller 40 may receive weight data from each of the plurality of weight sensors 80.

It should be appreciated that the one or more weight sensor(s) 80 may be any suitable device configured to sense the weight of an object positioned on the top plate 12 of the induction cooker 10. For example, the one or more weight sensor(s) 80 may be a load cell sensor configured to sense a weight of the cookware item 16. It should also be appreciated that the one or more weight sensor(s) 80 may transmit an electrical signal (e.g., analog) indicating a magnitude of a force (F) generated when the cookware item 16 is positioned on the top plate 12 of the induction cooker. Further, the one or more weight sensor(s) 80 may be configured to detect variations in the force F caused by the addition of the food item to the cavity of the cookware item 16. Thus, as will be discussed below in more detail, the controller 40 may be configured to determine the weight of both the cookware item 16 and the food item contained therein.

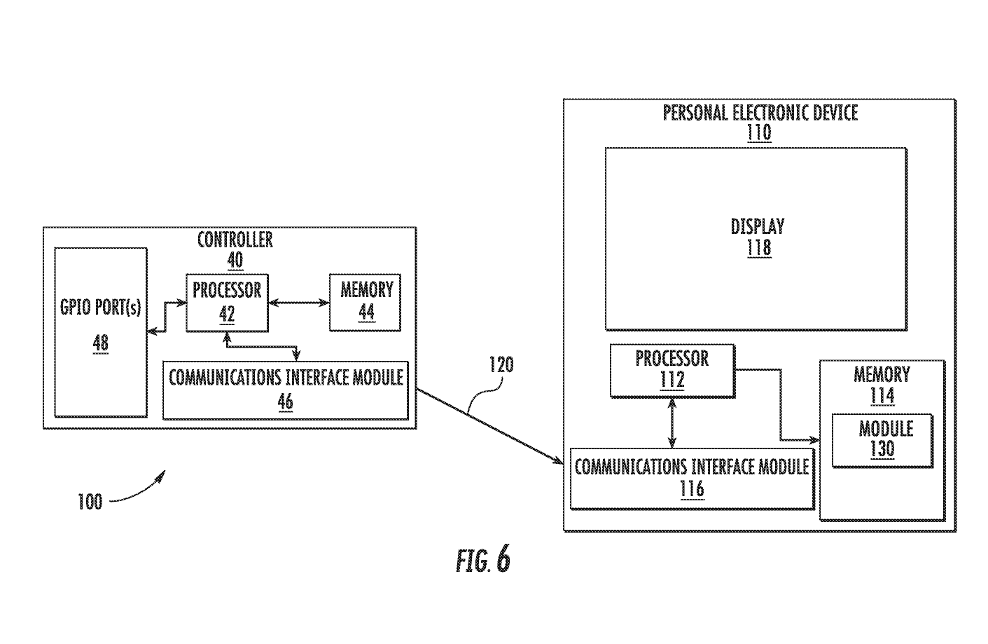

FIG. 6 provides a block diagram of a system 100 for controlling the operation of the induction cooker 10. The system 100 includes the controller 40 of the induction cooker 10 and a personal electronic device 110. The personal electronic device 110 may include one or more processor(s) 112 and associated memory 114 configured to perform a variety of computer-implemented functions (e.g., performing the methods, steps, calculations and the like disclosed herein). As used herein, the term “processor” refers not only to integrated circuits referred to in the art as being included in a computer, but also refers to a controller, microcontroller, a microcomputer, a programmable logic controller (PLC), an application specific integrated circuit (ASIC), and other programmable circuits. Additionally, the memory 44 may generally include memory element(s) including, but not limited to, a computer readable medium (e.g., random access memory (RAM)), computer readable non-volatile medium (e.g., flash memory), a floppy disk, a compact disc-read only memory (CD-ROM), a magneto-optical disk (MOD), a digital versatile disc (DVD) and/or other suitable memory elements.

The personal electronic device 110 may also include a communications interface module 116. The communications interface module 116 includes associated electronic circuitry that is used to both send and receive data. As an example, the communications interface module 116 may be used to send and receive data to and from the personal electronic device 110. It should be appreciated that the communications interface module 116 may be any suitable wired or wireless communications interface module. For example, the communications interface module 116 may provide communication between the controller 40 and the personal electronic device 110 over a wireless personal area network (WPAN). More specifically, the WPAN may be based on the Bluetooth® protocol. In other embodiments, the communications interface module 116 may provide communication between the controller 40 and the personal electronic device 110 over a serial communications interface. In particular, the serial communications interface may be based on the Universal Serial Bus (USB) protocol.

The personal electronic device 110 may also include a display 118. The display 118 may be an LCD display configured to display data. For example, data 120 received from the controller 40 may be presented on the display 118. In one embodiment, the data 120 may indicate a weight of the food item contained in the cavity of the cookware item 16. In another embodiment, the data 120 may indicate a food type may be selected using one or more of the plurality of buttons 34, and may generally include categories such as meat, fish, pasta, or any other suitable category. In yet another exemplary embodiment, the data 120 may indicate a cooking parameter. More specifically, the cooking parameter may be a cook time selected by the user via one or more of the plurality of buttons 34. Alternatively, the cooking parameter may be a power or heating level selected by the user via one or more of the plurality of buttons 34.

The selected heating level may, as an example, correspond to a numerical value on a scale between zero (0) and ten (10). Further, the selected numerical value may affect the amount of electric current flowing through the induction coil 50, which may also affect the magnitude of the time varying magnetic field. Still further, varying the magnitude of the time varying magnetic field may affect the magnitude of the eddy currents created in the cookware item 16, which may affect the temperature of the cookware item 16. Thus, the selected heating level dictates how fast or slow the food item cooks.

It should be appreciated that the data 120 received from the controller 40 of the induction cooker 10 may include both of the cooking parameter mentioned above. For example, in one exemplary embodiment, the data 120 may include the weight of the food item, the selected food type, the selected cook time, and the selected heating level.

The personal electronic device 110 may include a module 130 stored in the memory 114. In particular, the module 130 may, when executed by the processor 112, configure the personal electronic device 110 to determine an adjusted operating mode of the induction cooker 10 based, at least in part, on the data received from the controller 40. Specifically, the personal electronic device 110 may, when executing the module 130, adjust the selected cook time based, at least in part, on the weight of the food item, the selected food type, and/or the selected heating level. For example, if the selected food type and determined weight indicate the food item is a delicate food item, such as a cream sauce, the personal electronic device 110 may, when executing the module 130, automatically adjust the selected cook time rather than the heating level in order to avoid or limit heating the delicate food item to a high temperature. As another example, if the selected food type and determined weight indicate the food item is a robust food item, such as meat, the personal electric device 110 may increase or decrease the selected cook time as a function of the selected heating level. For instance, if the selected heating level is relatively low (e.g., 1-4), the personal electronic device 110 may increase the selected cook time. In contrast, if the selected heating level is relatively high (e.g., 7-10), the personal electronic device 110 may decrease the cook time.

Alternatively, the personal electronic device 110 may, when executing the module 130, adjust the selected heating level based, at least in part, on the weight of the food item, the selected food type, and/or the selected heating level. In yet another exemplary embodiment, the personal electronic device 110 may, when executing the module 130, adjust both the selected heating level and the selected cooking time based, at least in part, on the weight of the food item and/or the selected food type. For example, if the selected food type and determined weight indicate the food item is a food product having a significant weight, the personal electronic device 110 may, when executing the module 130, automatically adjust the selected heating level. Specifically, the personal electronic device 100 may increase or decrease the selected heating level as a function of the selected cook time. For instance, if the personal electronic device 110, when executing the module 130, determines the selected cook time is relatively short in view of the selected food type and determined weight of the food item, the personal electronic device 110 may increase the selected heating level. In contrast, if the personal electronic device 110 determines the selected cook time is relatively long in view of the selected food type and determined weight of the food item, the personal electronic device 110 may decrease the selected heating level.

As another example, if the selected food type and determined weight indicate the food item constitutes a relatively large amount of food, such as pasta, the personal electronic device 110 may, when executing the module 130, automatically adjust both the selected heating level and cook time. Specifically, the personal electronic device 110 may increase the heating level and decrease the cook time. Thus, the food item, specifically the pasta, may be cooked in a more efficient manner.

In one exemplary embodiment, a graphical user interface (GUI)/app may be presented on the display 118 when the personal electronic device 110 is executing the module 130. In particular, the GUI/app may allow a user to initiate the automated process mentioned above in which the personal electronic device 110 determines an adjusted cooking time and/or an adjusted heating level based, at least in part, on the selected food type and/or the weight of the food item. For example, the user may select a radio button or other textual element on the display 118 to initiate the automated process. Further, the GUI/app may also allow the user to override the automated process, and may instead manually adjust the selected cooking time and/or heating level.

It should be appreciated that, in alternative exemplary embodiments, the module 130 may be stored in the memory 44 of the controller 40. Thus, the controller 40 may, when executing the module 130, be configured to automatically adjust the selected cooking time and/or the selected heating level based, at least in part, on the weight of the food item and/or the selected food type.

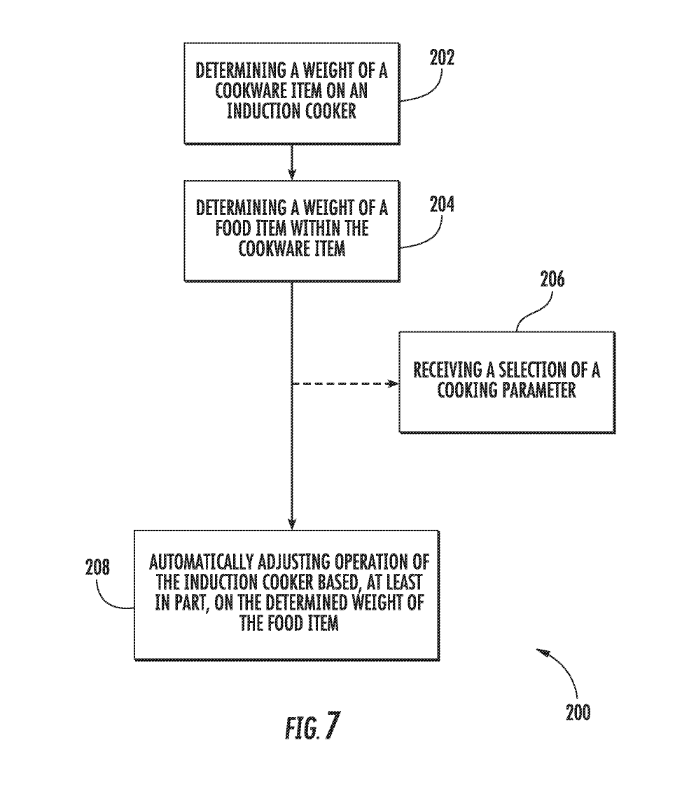

Referring now to FIG. 7, a flow diagram of one embodiment of a method 200 for controlling the operation of an induction cooker is illustrated in accordance with exemplary aspects of the present disclosure. In general, the method 200 will be discussed herein with reference to the induction cooker 10 and system 100 described above with reference to FIGS. 1-6. However, it should be appreciated by those of ordinary skill in the art that the disclosed method 200 may generally be implemented with induction cookers having any suitable configuration and/or with systems having any other suitable configuration. In addition, although FIG. 7 depicts steps performed in a particular order for purposes of illustration and discussion, the methods discussed herein are not limited to any particular order or arrangement. One of ordinary skill in the art, using the disclosure provided herein, will appreciate that various steps of the methods disclosed herein can be omitted rearranged, combined, and/or adapted in various ways without deviating from the scope of the present disclosure.

As shown in FIG. 7, at (202), the method 200 may include determining, by a controller of the induction cooker, a weight of a cookware item positioned on the induction cooker. Specifically, in one exemplary embodiment, the controller determines the weight of the cookware item based, at least in part, on a first set of weight data received from one or more weight sensor(s) mounted on a bottom surface of the induction cooker.

Additionally, at (204), the method 200 may include determining, by the controller of the induction cooker, a weight of a food item disposed within the cookware item. Specifically, in one exemplary embodiment, the food item may be added to cookware item subsequent to the controller determining the weight of the cookware item. Further, the controller may receive a second set of weight data from the one or more weight sensor(s) indicating a combined weight of both the cookware item and the food item. Still further, the controller may be configured to determine the weight of the food item based, at least in part, on the difference in magnitude between the second set of weight data and the first set of weight data.

Moreover, at (206), the method 200 may include receiving, by the controller, a cooking parameter. Specifically, in one exemplary embodiment, the controller may receive the cooking parameter via manipulation of one or more button(s) located on a control panel of the induction cooker. For example, the user may use the one or more button(s) on the control panel to select a cooking time for the food item. Alternatively, or in addition to, the user may use the one or more button(s) to select a heating level which, as discussed above, may dictate a rate at which the food item cooks. In addition to the cooking parameter, the user may use the one or more button(s) to select a food type of the food item contained in the cookware item.

Further, at (208), the method 200 may include automatically adjusting the operation of the induction cooker based, at least in part, on the determined weight of the food item and/or the selected food type. Specifically, the controller may be configured to automatically adjust the cooking parameter (that is, the cooking time and/or heating level) based, at least in part, on the determined weight of the food item and/or the selected food type. For example, if the food item is relatively light, the controller may reduce the cooking time and/or heating level. Conversely, the controller may increase the cooking time and/or heating level if the food item is relatively heavy. In one exemplary embodiment, the controller may be configured to automatically adjust the cooking parameter.

Alternatively, the controller may communicate the determined weight of the food item, the selected food type, and the selected the cooking parameter to a personal electronic device. Specifically, the personal electronic device may be configured to automatically adjust the cooking parameter, specifically the selected cooking time and/or the selected heating level, based, at least in part, on the determined weight of the food item and/or the selected food type. Further, the personal electronic device may be configured to transmit the automatically adjusted cooking parameter to the controller of the induction cooker. Still further, the controller may be configured to adjust the operation of the induction cooker to reflect the one or more automatically adjusted cooking parameter(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for controlling the operation of an induction cooker, the method comprising:
determining, by a controller of the induction cooker, a weight of a cookware item positioned on the induction cooker;
determining, by the controller of the induction cooker, a weight of a food item disposed within the cookware item; and
automatically adjusting the operation of the induction cooker based, at least in part, on the determined weight of the food item.

2. The method of claim 1, wherein automatically adjusting the operation of the induction cooker includes automatically adjusting a cooking parameter of the induction cooker based, at least in part, on the determined weight of the food item.

3. The method of claim 2, wherein the cooking parameter is selected via a control panel of the induction cooker.

4. The method of claim 2, wherein the cooking parameter includes at least one of a cook time and a heating level.

5. The method of claim 4, wherein automatically adjusting the cooking parameter includes adjusting the cook time.

6. The method of claim 4, wherein automatically adjusting the cooking parameter includes adjusting the heating level.

7. The method of claim 4, wherein automatically adjusting the cooking parameter includes adjusting both the cook time and the heating level.

8. The method of claim 3, further comprising communicating both the determined weight of the food item and the selected cooking parameter to a personal electronic device.

9. The method of claim 8, wherein automatically adjusting includes automatically adjusting, by the personal electronic device, the selected cooking parameter based, at least in part, on the determined weight of the food item.

10. The method of claim 9, further comprising communicating the automatically adjusted cooking parameter to the controller of the induction cooker.

11. A system for controlling the operation of an induction cooker, the system comprising:
a controller of the induction cooker that is communicatively coupled to a weight sensor of the induction cooker, the controller configured to determine a weight of a cookware item positioned on the induction cooker, the controller further configured to determine a weight of a food item within a cookware item positioned on the induction cooker; and
a personal electronic device in communication with the controller, the personal electronic device configured to receive data from the controller indicating at least the determined weight of the food item,
wherein the controller or the personal electronic device is configured to automatically adjust the operation of the induction cooker based, at least in part, on the determined weight of the food item.

12. The system of claim 11, wherein the controller is operatively coupled to a control panel of the induction cooker, wherein the control panel includes a display and a plurality of buttons, and wherein the controller is configured to receive a cooking parameter via the plurality of buttons.

13. The system of claim 12, wherein the cooking parameter includes at least one of a cooking time and a heating level.

14. The system of claim 12, wherein the controller is configured to automatically adjust the cooking parameter based, at least in part, on the determined weight of the food item.

15. The system of claim 12, wherein the data received from the controller includes the determined weight of the food item and the cooking parameter.

16. The system of claim 15, wherein the personal electronic device is configured to automatically adjust the operation of the induction cooker based, at least in part, on both the determined weight of the food item and the selected cooking parameter.

17. The system of claim 15, wherein the personal electronic device includes a display, and wherein the personal electronic device is configured to present both the determined weight of the food and the selected cooking parameter on the display.

18. The system of claim 12, wherein the weight sensor includes a plurality of weight sensors mounted to a bottom surface of the induction cooker.
